(19) United States
(12) Patent Application Publication
(10) Pub. No.: US 2005/0002733 A1
(43) Pub. Date: Jan. 6, 2005

(54) Tension member termination

(75) Inventor: Bjorn Paulshus, Skedsmokorset (NO)

Correspondence Address: THOMAS W. TOLPIN;WELSH & KATZ, LTD., 120 SOUTH RIVERSIDE PLAZA, 22ND FLOOR, CHICAGO, IL, 60606, US

(73) Assignee: Deep Water Composites AS

(21) Appl. No.: 10/800,294

(22) Filed: Mar. 12, 2004

Related U.S. Application Data
(63) Continuation of application No. 09/871,609, filed on May 31, 2001, now abandoned.
(63) Continuation of application No. PCT/NO98/00077, filed on Mar. 6, 1998.

(30) Foreign Application Priority Data
May 31, 2000 (NO) 2000 2811
Mar. 7, 1997 (NO) 971053
Mar. 7, 1997 (NO) 971054

(51) Int. Cl. F16D 1/00

(52) U.S. Cl. 403/305

(57) ABSTRACT

A termination of a tension member (1) for use as a tension leg for a tension leg platform. The tension member (1) consists of a plurality of carbon fiber filaments gathered into one or more strands (2) in which the filaments run close together. Around the strands is provided a sheath. The bundles/strands (2) are spread apart in a transitional zone, and each bundle/strand is inserted into its respective hole (6) in a socket (4, 5), and is fixed in relation to the hole (6) by means of a hardenable mass.

The present invention relates to a tension member termination in accordance with the preamble of claim 1.

The tension member according to the invention is intended for use primarily in connection with tension legs for a tension leg platform, but other applications are also relevant, such as in stays or wires for bridges (for example, suspension bridges or inclined strut bridges), anchoring of tunnels, or other uses where there is a need for a light and strong wire or stay. The invention is therefore not limited to the utilization described in the following.

Tension leg platforms are widely used in drilling and production in oil fields where for various reasons it is not possible or economically justifiable to install a permanent platform, and where it would not be practical to use a floating platform anchored by means of anchors and anchor chains.

The tension leg platforms are in principle floating platforms where, however, instead of a slack anchoring with the aid of anchors and anchor chains, there are tension legs extending from the platform approximately vertically down to an anchor on the seabed. The tension legs are placed under a substantial degree of tension so that, to the extent possible, the platform will be maintained in the same position relative to the seabed. The platform's stable position is a great advantage in both drilling and production. However, this places high demands on the tension legs being used and on their attachment to the platform and their anchoring on the seabed.

Today's tension legs consist of steel tubing in sections. The sections may have unequal lengths, have unequal diameters, and exhibit various wall thicknesses, depending on the size of the platform and the depth of the water. The legs are always constructed as tubes having an air-filled cavity, so that the weight of the leg in the water is greatly reduced. This places a lighter load on the platform. The dimensioning of the leg in relation to external water pressure is therefore a design criterion. These steel legs function well at moderate depths, i.e., depths of a few hundred meters. However, oil and gas production now takes place at increasingly greater depths, possibly up to 2000 meters. Under such conditions, there are great demands placed on the strength of the tension legs, and a tension leg of steel would not be usable. The thickness of the wall would then, out of consideration for the increased water pressure, have to be very great, and the pipes would thereby become extremely heavy. For transport reasons they would also have to consist of a great many sections that would need to be joined together during installation. The tension legs would thereby acquire a considerable number of joints, which would also contribute to the substantial weight increase. To counteract the increase in weight, it could be advisable to equip the legs with a large number of buoyancy members. All this would result in an extremely expensive and heavy installation.

Carbon fibers, with their low weight and high tensile strength, have already been put to use in various areas in connection with oil and gas extraction, for example, as hoisting cables at great depths, where the weight of a hoisting cable made of steel would create problems.

It is an aim according to the present invention to exploit the advantageous properties of the carbon fibers, particularly their high strength when subjected to tensile stresses, by utilizing them also in tension legs. However, the carbon fibers do also have one significant negative property: they have very little rupture strength in the face of shearing stresses. In the termination of a tension leg consisting of carbon fibers, this factor would have to be taken into consideration.

According to the present invention, the intention is to provide a termination for a tension leg made preferably of carbon fiber, which can be used for tension leg platforms at great depths, where the carbon fibers are not subjected to shearing stresses. However, other fiber materials having approximately the same properties as carbon fibers could also be used—for example, Kevlar or glass fiber.

There are known examples of the use of a hardening mass to terminate a tension member in a receiving body, or socket.

U.S. Pat. No. 5,611,636 shows a termination of a cable where the cable filaments are inserted into a socket. With the aid of an eye at the end of the socket, this can be connected to a fixed point or another object. According to this publication, the entire tension member is terminated in the same hole in the socket.

U.S. Pat. No. 4,673,309 shows a method for anchoring a cable in a socket. Here, also, the whole tension member is terminated in the same opening in the socket.

GB 1571327 (DE 2700378) shows a termination for a tension member. Here, also, the entire tension member is terminated in the same hole in the socket.

From DE 2407828 there is known a tension member termination where the filaments are anchored together in a binder material. In addition, the filaments are connected to an anchor plate that is embedded in the binder material.

Termination of these types of tension legs requires special arrangements, since the carbon fiber filaments could otherwise rupture easily, and the tension leg could thereby be considerably weakened or, in the worst case, collapse completely. It is therefore not advisable to anchor the whole tension member in the same opening in a socket. This would result in an unequal load on the individual strands or filaments, and a rupture could easily occur. Particularly with tension members having a large diameter and a great number of filaments, it would not be possible to anchor the entire tension member in the same hole.

A convenient termination of such tension members is described in the Norwegian patents 304 438 and 304 904 by the same applicant. According to NO 304 438, the strands are terminated in a socket by the individual anchoring of the strands in the socket with the aid of a hardenable mass.

However, it has now been discovered that it is possible to terminate all the filaments of one strand in the same hole without thereby causing the occurrence of unacceptably uneven loads on the individual filaments.

The purpose of the present invention is to provide a simpler termination of a tension member than what is described in the aforementioned Norwegian patents, which still provides for the necessary security against breakage.

The invention will now be explained in more detail, with reference to the accompanying figures, where:

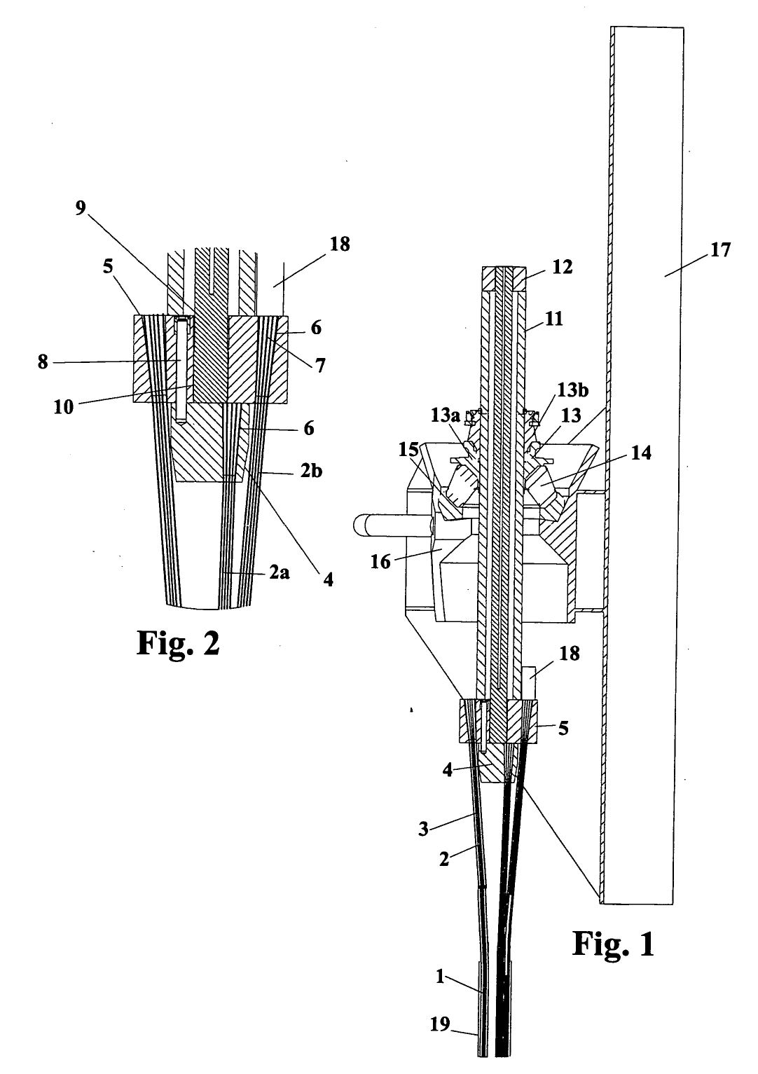

FIG. 1 is a sectional view through the termination and

FIG. 2 shows an enlarged section of FIG. 1.

In FIG. 1 there is shown a preferred embodiment form of a termination according to the present invention. A tension member 1 is made up of a plurality of strands 2, which in turn are composed of individual filaments or rods 3 which may be made, for example, of carbon, in a quantity of between 31 and 127 in each strand. The construction of this type of tension leg is described at great length in NO 304839 and in a Norwegian patent application by the same applicant having the same filing date as the present application. This construction will therefore not be described in detail here, but it should be mentioned that the filaments or rods 3 in strands 2 are wound about the longitudinal axis of the strand. The strands are movable in the longitudinal direction relative to each other and are wound about the longitudinal axis of tension member 1. The strands are preferably arranged in two or more rings or layers around the center axis of the tension member 1.

In a transitional zone near the end of the tension member, the strands are spread apart.

Here, there is preferably provided a funnel-shaped sleeve (not shown) to control the spreading of strands 2. The termination comprises a first plate 4 and a second plate 5, which function as receiving bodies, or sockets. Each of plates 4 and 5 is provided with a plurality of conical holes 6, arranged in one or more rings around the center of plate 4, 5. The holes 6 extend through plate 4, 5 and have an increasing cross section in the direction away from tension member 1. The first plate 4 has a smaller diameter than the second plate 5, such that the diameter of the first plate 4 falls within the bounds of holes 6 in the second plate 5. Strands 2a in the innermost ring or layer in tension member 1 are preferably threaded into holes 6 in the first plate, whereas strands 2b in the outermost ring or layer in tension member 1 are preferably threaded into holes 6 in the second ring 5. However, it is also conceivable that all the strands can be anchored in the same plate or that strands from the same layer can be anchored in different plates.

In the case of a tension member having more than two layers, the strands from different layers can be anchored in the same plate or, alternatively, the number of plates may be increased.

Holes 6 are preferably oriented such that the narrower end is pointed inward toward the center of plate 4, 5, since strands 2 also have this direction.

Strands 2 are each threaded into their respective holes 6 in plates 4, 5. A slip agent is applied beforehand to the walls 6 of the hole. After the strands are inserted, the hole is filled with a hardenable mass 7. Due to the applied slip agent, the hardenable mass 7 will not adhere to the walls of hole 6. Since hole 6 is conical, it will not be possible to extract strand 2 with the hardened mass 7 from hole 6 in the direction toward tension member 1. On the contrary, a tension exerted on strand 2 will cause the hardened mass to compress and to hold the carbon filaments 3 with a greater force than could be expected by adhesion alone.

The first plate 4 is attached to the second plate 5 with the aid of a plurality of prestressed bolts 8, which are preferably disposed along a circle within the bounds of holes 6 in the second plate 5. The joining of the two plates takes place after strands 2a have been secured in holes 6 in the first plate 4.

A retention screw 9 is attached to the second plate 5 via a central bore 10. Bore 10 may be provided with an internal thread corresponding to an external thread on screw 9. Outside screw 9 is placed a sleeve 11, which rests upon the top of the second plate 5. A nut 12 is screwed onto screw 9 and abuts with the opposite end of sleeve 11, so that sleeve 11 is held securely between nut 12 and the second plate 5.

Instead of securing sleeve 11 in this manner, it may alternatively be equipped with a flange that is attached to the second plate 5 with the aid of bolts. This, however, requires having a larger diameter at disposal on the top of plate 5.

Sleeve 11 is further connected to a flange device 13, which rests on an axial bearing 14, which in turn rests on a seat 15 in a retention ring 16. The retention ring forms an integral part of the structure 17 to which the tension member is to be connected, for example a platform or a foundation. Flange device 13 is preferably connected with sleeve 11 in a manner permitting the adjustment of the tension in the tension member by moving flange device 13 along sleeve 11. This effect can be realized, for example, by means of a threaded connection. In the embodiment example, flange device 13 consists of two parts, a non-rotating part 13a, which is firmly connected to axial bearing 14, and a rotatable part 13b, which is threadably connected with sleeve 11 and which rests on non-rotating part 13a. With the aid of known per se means, not shown, the rotatable part 13b is rotated in order to increase, or to reduce, the tension in tension member 1. Sleeve 11 thereby functions as a tightening screw.

In some of the strands 2 there are embedded optical fibers (not shown). These are used to measure the tension in tension member 1. Since the strands 2b that are secured in the second plate 5 terminate on the top of this plate 5, there will be free access to the optical fibers embedded in these strands 2b. Therefore, over these strands 2b on top of plate 5 there may be provided a junction box 18 in which the optical fibers can terminate. The actual coupling of the optical fibers to the junction box and the function thereof are well known to a person versed in the art and will therefore not be explained in further detail here.

The aforementioned is only one embodiment example of the present invention. Instead of securing several strands in the same plate, however, the strands may also be secured one-by-one in separate sockets, which in turn are suspended in a suspension body, for example as described in NO 304 904.

(6) in a socket (4, 5), and is fixed in relation to the hole (6) by means of a hardenable mass.

1-10. (canceled)

11. A termination of strands in a tension member, which tension member comprises an anchoring element comprising fibers selected from the group consisting of carbon fibers and aramid fibers, said fibers of said anchoring element gathered into one or more strands, said fibers having a lower shear force and durability than steel, wherein the strands are spread apart in a transitional region, and each strand is inserted into its respective hole in at least one socket, and is fixed in relation to the hole by means of hardenable mass, and wherein a slip agent is applied to the walls of each hole, so that the hardenable mass is prevented from adhering to the walls of the hole.

12. The termination according to claim 1, wherein a plurality of said strands are each anchored in their respective holes in the same plates so that the plurality of strands are anchored in a socket.

13. The termination according to claim 1, wherein each hole tapers inward in the direction toward the tension member.

14. The termination according to claim 1, wherein it comprises at least two sockets, a first socket and a second socket, which are joined together, where the first socket has a smaller diameter than the second socket, allowing at least one of the strands secured in the second socket to extend beyond the first socket.

15. A termination of strands in a tension member, which tension member comprises a plurality of fiber filaments gathered into one or more strands, in which the filaments run close together, wherein the strands are spread apart in a transitional region, and each strand is inserted into its respective hole in one of at least two sockets, and is fixed in relation to the hole by means of hardenable mass, wherein a plurality of strands are each anchored in their respective holes in the same plates;
said termination comprising at least two sockets, including a first socket and a second socket which are joined together, where the first socket has a smaller diameter than the second socket, allowing at least one of the strands secured in the second socket to extend beyond the first socket; and
wherein the first socket and the second socket are positioned in concentric relationship with one another and are connected via adjoining surfaces; and wherein a sleeve-shaped tightening screw is connected to the second socket.

16. The termination according to claim 5, wherein each hole tapers inward in the direction toward the tension member.

17. The termination according to claim 5, wherein a slip agent is applied to the walls of each hole, so that the hardenable mass is prevented from adhering to the walls of the hole.

18. The termination according to claims 5, wherein a tightening screw is connected to the second socket.

19. The termination according to claim 5, wherein at least one of the ends of at least of the strands secured in the second socket are accessible at a surface of the second socket opposite the tension member such that there is access to an optical fiber in the strand and that the necessary connecting equipment of the optical fiber can be placed above the second socket.

20. A termination of strands in a tension member, which tension member comprises a plurality of fiber filaments gathered into one or more strands, in which the filaments run close together, wherein the strands are spread apart in a transitional region, and each strand is inserted into its respective hole in one of at least two sockets, and is fixed in relation to the hole by means of hardenable mass, wherein a plurality of strands are each anchored in their respective holes in the one of at least two sockets;
said termination comprising at least two sockets, including a first socket and a second socket which are joined together, where the first socket has a smaller diameter than the second socket, allowing at least one of the strands secured in the second socket to extend beyond the first socket;
a tightening screw is connected to the second socket; and wherein a retention screw is connected to the second socket, that the retention screw is provided with a nut and the nut securely holds the sleeve-shaped tightening screw between itself and the second socket.

21. A termination of strands in a tension member, which tension member comprises a plurality of fiber filaments gathered into one or more strands, in which the filaments run close together, wherein the strands are spread apart in a transitional region, and each strand is inserted into its respective hole in one of at least two sockets, and is fixed in relation to the hole by means of hardenable mass, wherein a plurality of strands are each anchored in their respective holes in said one of at least two sockets;
said termination comprising at least two sockets, including a first socket and a second socket which are joined together, where the first socket has a smaller diameter than the second socket, allowing at least one of the strands secured in the second socket to extend beyond the first socket; and wherein
the sockets are attached to one another by means of prestressed bolts, which extend through a through bore in the second socket and down into a threaded blind hole in the first socket.
